(19) United States
(12) Patent Application Publication
(10) Pub. No.: US 2025/0119579 A1
(43) Pub. Date: Apr. 10, 2025

(54) COORDINATE REFINEMENT AND UPSAMPLING FROM QUANTIZED POINT CLOUD RECONSTRUCTION

(71) Applicant: InterDigital VC Holdings, Inc., Wilmington, DE (US)

(72) Inventors: Muhammad Asad Lodhi, Highland Park, NJ (US); Jiahao Pang, Plainsboro, NJ (US); Dong Tian, Boxborough, MA (US)

(73) Assignee: InterDigital VC Holdings, Inc., Wilmington, DE (US)

(21) Appl. No.: 18/727,856

(22) PCT Filed: Jan. 10, 2023
(86) PCT No.: PCT/US2023/010488

§ 371 Date: Jul. 10, 2024

Related U.S. Application Data
(60) Provisional application No. 63/297,894, filed on Jan. 10, 2022.
(60) Provisional application No. 63/417,226, filed on Oct. 18, 2022.

(51) Int. Cl. H04N 19/597; H04N 19/105; H04N 19/17

(52) U.S. Cl. CPC H04N 19/597; H04N 19/105; H04N 19/17

(57) ABSTRACT

Systems, methods, and instrumentalities are disclosed for coordinate refinement and/or up-sampling from quantized point cloud reconstruction. In examples, point-based coordinate refinement may be provided. An after-decoder point cloud refinement module may include one or more of the following. The module may include accessing a decoded quantized version of a point cloud. The module may include accessing and/or fetching point(s) within a neighborhood area of each of the point(s). A feature may be computed using a point-based neural network module, for example, based on the three-dimensional (3D) (e.g., or KD) location(s) of the fetched points, e.g., that summarizes the details (e.g., intricate details). A refinement offset for the current, point may be predicted based on the comprehensive featuring using a fully connected (FC) module.

### CROSS REFERENCE

The application claims the benefit of U.S. Patent Application 63/297,894, filed Jan. 10, 2022, and U.S. Patent Application 63/417,226, filed Oct. 18, 2022, the contents of which are incorporated by reference in their entirety herein.

### BACKGROUND

Video coding systems may be used to compress digital video signals, for example, to reduce the storage and/or transmission bandwidth needed for such signals. Video coding systems may include, for example, wavelet-based systems, object-based systems, and/or block-based systems, such as a block-based hybrid video coding system. Current tools used for compression and processing for point clouds may not be adequate.

### SUMMARY

Systems, methods, and instrumentalities are disclosed for coordinate refinement and/or up-sampling from quantized point cloud reconstruction. In examples, point-based coordinate refinement may be provided. An after-decoder point cloud refinement module may include one or more of the following. The module may include accessing a coarse or decoded quantized version of a point cloud. The module may include accessing and/or fetching point(s) within a neighborhood area of each of the point(s). The module may include computing a feature using a convolution-based neural network module, for example, based on the voxelized version of the fetched points, e.g., that summarizes the details (e.g., intricate details). Another feature may be computed using a point-based neural network module, for example, based on the three-dimensional (3D) (e.g., or KD) location(s) of the fetched points, e.g., that summarizes the details (e.g., intricate details). In examples, the feature(s) may be concatenated to compose a comprehensive feature. A refinement offset for the current point may be predicted based on the comprehensive featuring using a fully connected (FC) module.

In examples, coordinate up-sampling may be provided. An after-decoder point cloud up-sampling module (e.g., coarse point cloud up-sampling model) may include one or more of the following. A decoded quantized version of a point cloud (e.g., coarse point cloud) may be accessed. The module may include accessing and/or fetching point(s) within a neighborhood area of each of the points. A feature (e.g., hybrid feature) may be computed using a neural network module based on the fetched point(s). Offsets for new points relative to the current point may be predicted through an FC module using the compute feature.

Hierarchical feature propagation may be performed. For example, Hierarchical feature propagation may be performed using certain architectures (e.g., enhanced architectures) for position refinement and upsampling. For example. PointCRM and/or PointUPM architectures may be modified (e.g., enhanced) to perform hierarchical feature propagation. Hierarchical feature propagation may include upsampling features from a previous (e.g., parent, already decoded) level to match resolution of a current octree level. The upsampled features may be propagated, for example, to child nodes for predicting point refinements at the current level.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example video encoder.

FIG. 3 is a diagram showing an example of a video decoder.

FIG. 4 is a diagram showing an example of a system in which various aspects and examples may be implemented.

FIG. 5 shows an example of VoxelContextNet.

FIG. 6 shows an example of a basic point-based coordinate refinement module (PointCRM).

FIG. 7 shows an example of a multi-resolution grouping-enhanced (MRG-enhanced) PointCRM.

FIG. 8 shows an example of a multi-scale grouping-enhanced (MSG-enhanced) PointCRM.

FIG. 9 shows an example of a hybrid architecture.

FIG. 10 shows an example of a convolution-based branch.

FIG. 11 shows an example of a basic point-based up-sampling module (PointUPM).

FIG. 12 shows an example of a basic PointUPM with exact point matching.

FIG. 13 shows an example of a folding-enhanced PointUPM.

FIG. 14 shows an example of a prediction-based UPM.

FIG. 15 shows an example of hierarchical feature propagation.

FIG. 16 illustrates an example voxel branch based on sparse convolutions.

FIG. 17 illustrates an example voxel branch based on ResNet composed of sparse convolutions.

FIG. 18 illustrates an example of a voxel branch based on Inception ResNet composed of sparse convolutions.

FIG. 19 illustrates a diagram of an example point branch based on a transformer block.

FIG. 20 illustrates an example inter-coding diagram for dynamic point cloud compression.

FIG. 21 illustrates an example decoder for inter-coding for dynamic point cloud compression.

FIG. 22 illustrates an example updated inter-coding diagram.

FIG. 23 illustrates an example decoder using inter-prediction based on an enhanced reference PC.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

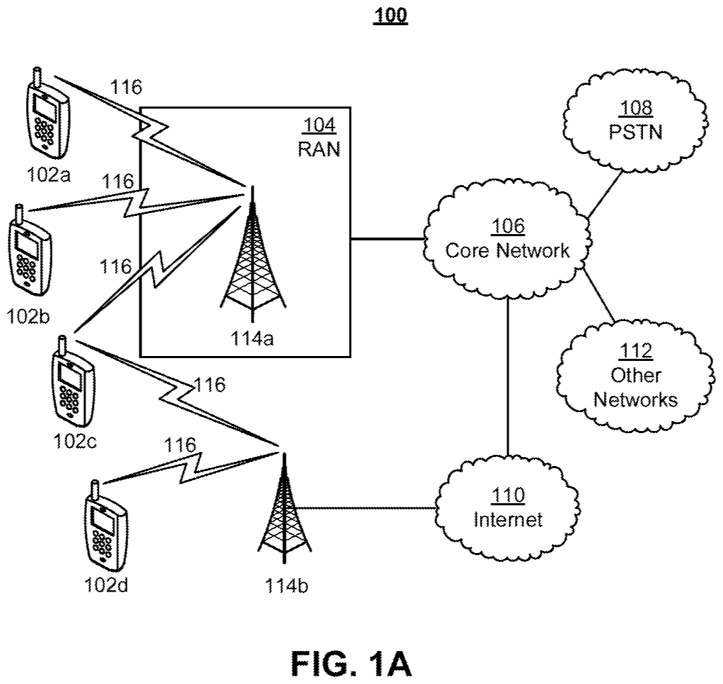

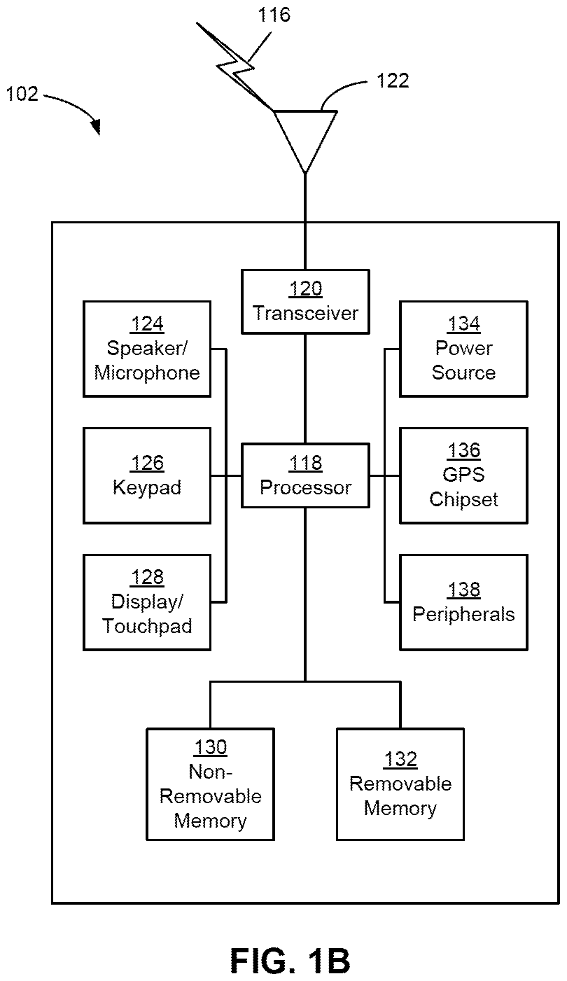

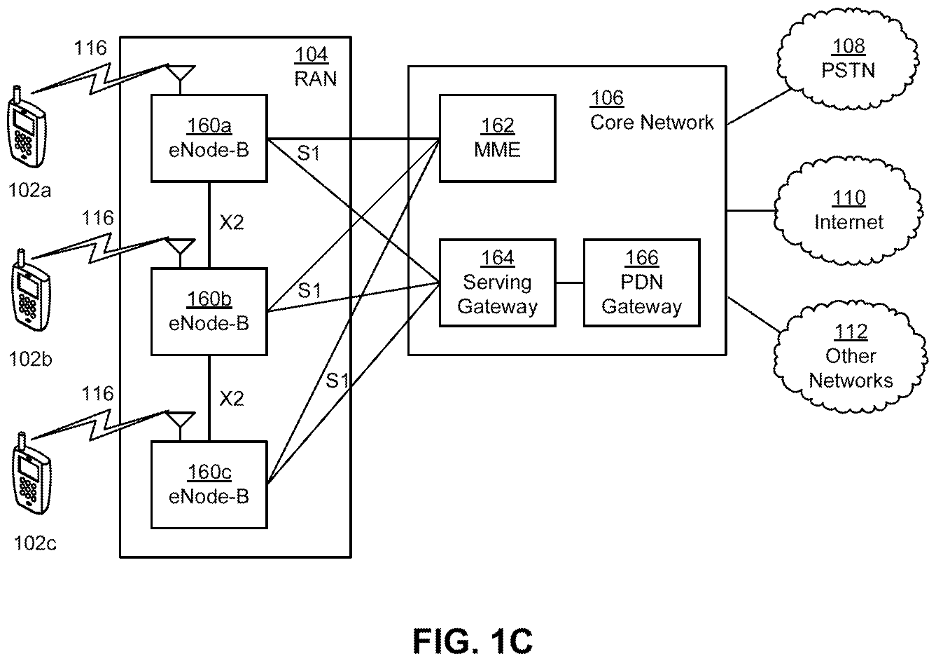

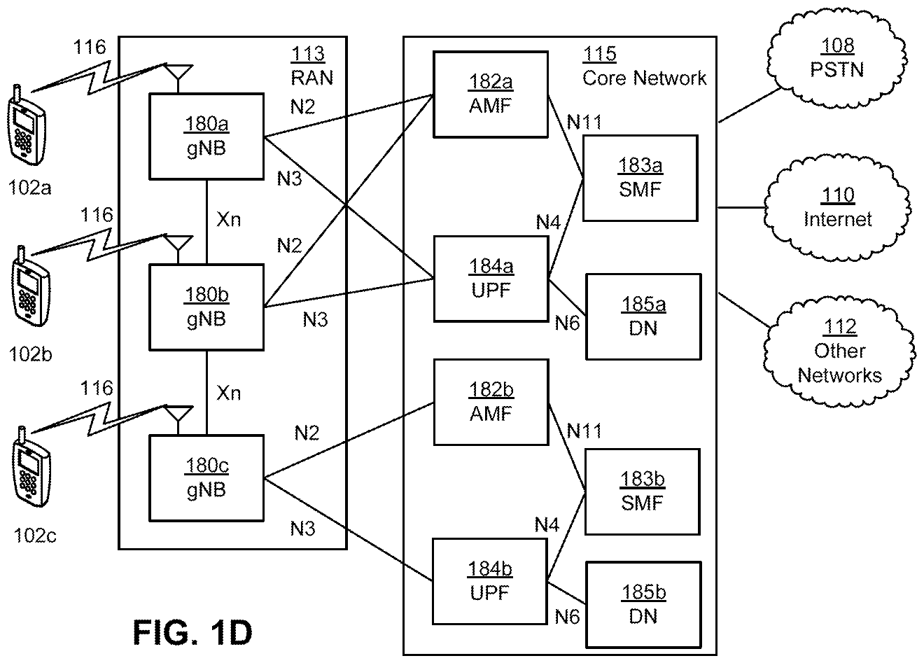

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a. 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856). Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c. 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 1061115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 1061115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b. 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a. 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR. UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, alight sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a. 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a. 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a. 102b. 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AR for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an ‘ad-hoc’ mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac, 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a. 102b. 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b. 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration. WTRUs 102a, 102b, 102c may utilize one or more of gNBs 180a, 180b, 180c as a mobility anchor point. In the standalone configuration, WTRUs 102a, 102b. 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a. 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a. 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b, and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

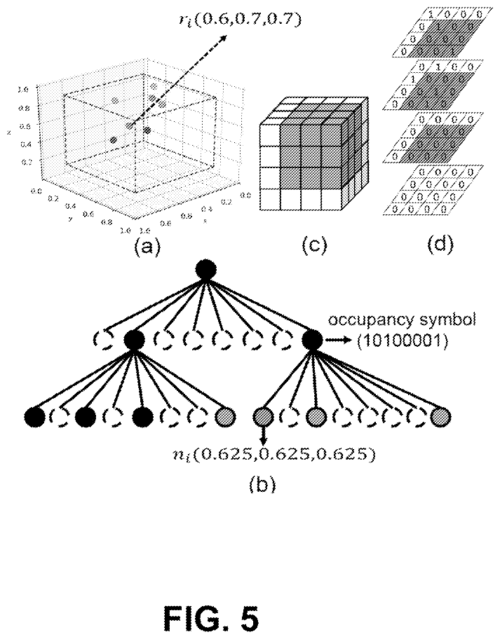

The aspects described and contemplated in this application may be implemented in many different forms. FIGS. 5-8 described herein may provide some embodiments, but other embodiments are contemplated. The discussion of FIGS. 5-8 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

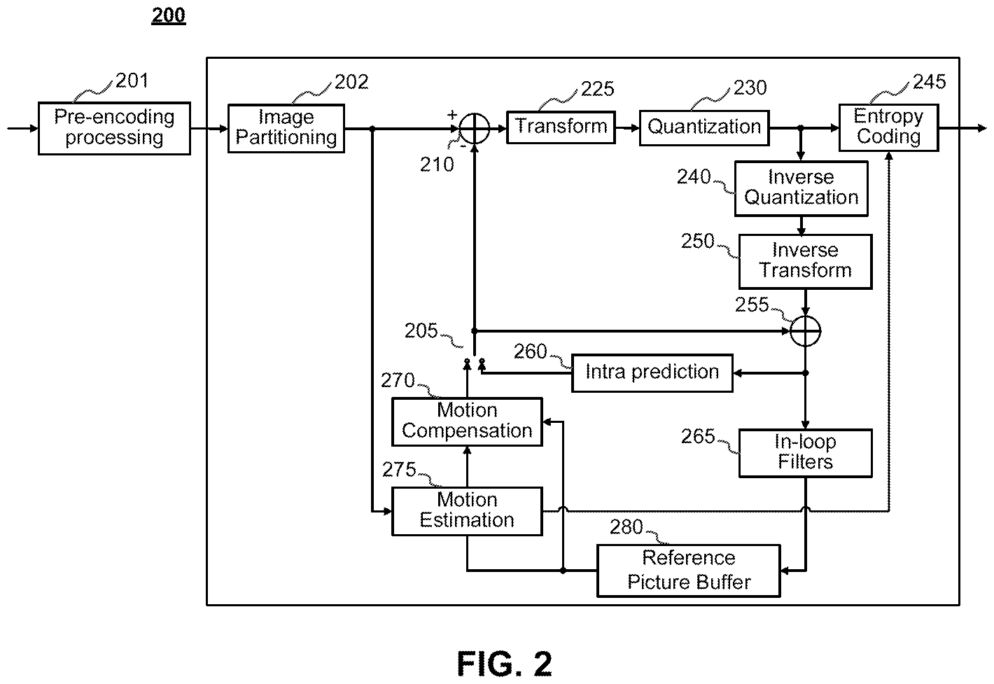

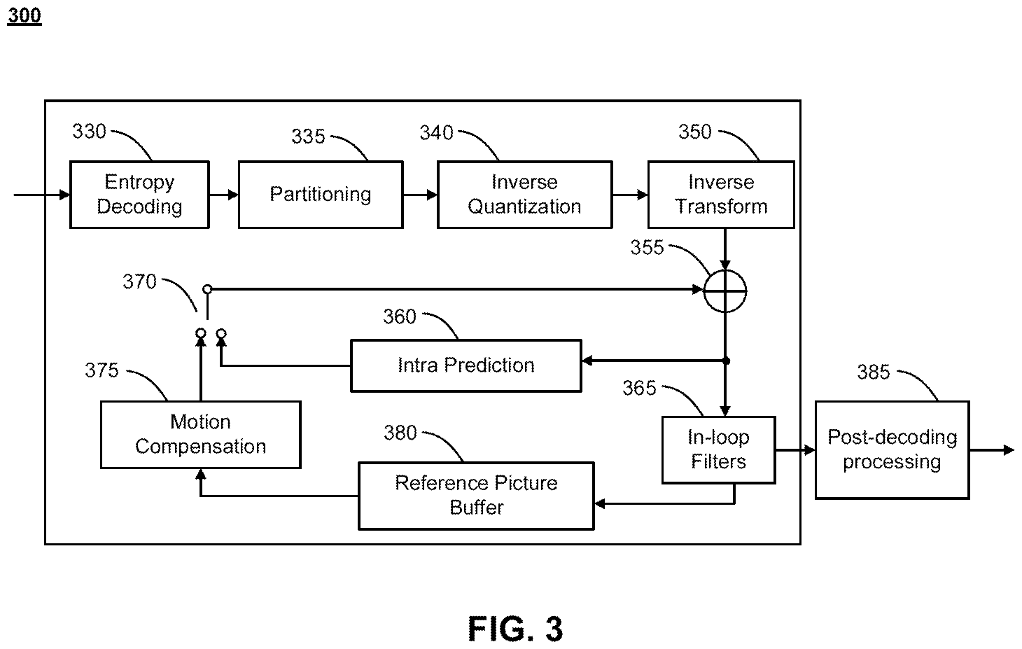

Various methods and other aspects described in this application may (for example, be used to) modify modules, for example, pre-encoding processing 201, intra prediction 260, entropy coding 245 and/or entropy decoding modules 330, intra prediction 360, post-decoding processing 385, of a video encoder 200 and a video decoder 300 as shown in FIG. 2 and FIG. 3 respectively. Moreover, the subject matter disclosed herein presents aspects that are not limited to VVC or HEVC, and may be applied, for example, to any type, format or version of video coding, whether described in a standard or a recommendation, whether pre-existing or future-developed, and extensions of any such standards and recommendations (e.g., including WC and HEVC). Unless indicated otherwise, or technically precluded, the aspects described in this application may be used individually or in combination.

Various numeric values are used in examples described the present application, such as minimum and maximum value ranges (for example, 0 to 1, 0 to N or 0 to 255), bit values for indications or determinations, default values, ID numbers (for example, for adaptation IDs), etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 44:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 may also generally perform video decoding as part of encoding video data. For example, the encoder 200 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

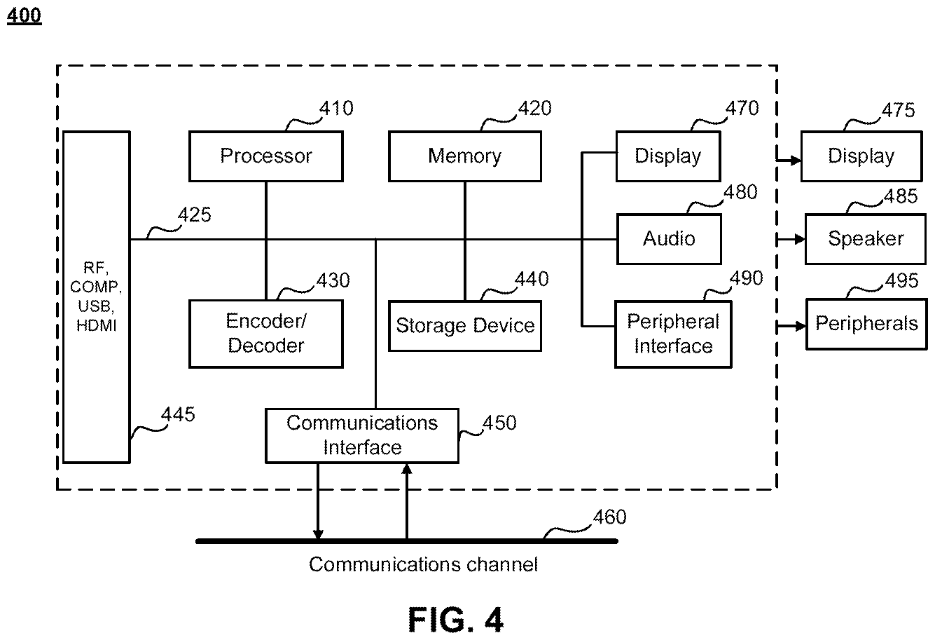

FIG. 4 is a diagram showing an example of a system in which various aspects and embodiments described herein may be implemented. System 400 may be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445. As indicated above, various embodiments provide data in a non-streaming manner. Additionally, various embodiments use wireless networks other than Wi-Fi, for example a cellular network or a Bluetooth network.

The system 400 can provide an output signal to various output devices, including a display 475, speakers 485, and other peripheral devices 495. The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400. For example, a disk player performs the function of playing the output of the system 400.

In various embodiments, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, receiving, decoding and interpreting signals (for example, as described herein) indicating elements, attributes and metadata associated with point cloud components; identifying point cloud streams and their component sub-streams within a media presentation descriptor (MPD); identifying versions of a point cloud and/or its components; decoding an MPD to identify a main adaptation set and other adaptation sets to identify geometry-based point cloud compression (G-PCC) components in G-PCC content; decoding an MPD to identify the type of point cloud component in an adaptation set or a representation; decoding an MPD to identify one or more preselections; decoding an MPD to identify one or more versions of G-PCC media; decoding an MPD to identify one or more G-PCC tile groups: decoding an MPD to identify one or more tile IDs for a G-PCC component in an adaptation set; decoding an MPD to identify one or more characteristics of spatial regions and mappings between the regions and G-PCC tiles, characteristics of spatial regions and mappings between the regions and corresponding adaptation sets of G-PCC components, and/or a mapping between a spatial region and corresponding adaptation sets of G-PCC components; decoding an MPD to identify a timed-metadata track for dynamic spatial regions: etc.

As further embodiments, in one example “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, generating, encoding and sending signals (for example, as described herein) indicating elements, attributes and metadata associated with point cloud components, encoding an MPD to indicate point cloud streams and their component sub-streams; encoding an MPD to indicate a main adaptation set and other adaptation sets to support identification of geometry-based point cloud compression (G-PCC) components in G-PCC content; encoding an MPD to support identification of the type of point cloud component in an adaptation set or a representation; encoding an MPD to identify one or more preselections; encoding an MPD to support identification of one or more versions of G-PCC media; encoding an MPD to support identification of one or more G-PCC tile groups; encoding an MPD to support identification of one or more tile IDs for a G-PCC component in an adaptation set; encoding an MPD to support identification of one or more characteristics of spatial regions and mappings between the regions and G-PCC tiles, characteristics of spatial regions and mappings between the regions and corresponding adaptation sets of G-PCC components, and/or a mapping between a spatial region and corresponding adaptation sets of G-PCC components; decoding an MPD to identify a timed-metadata track for dynamic spatial regions; etc.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as syntax elements that may be indicated in discussion or figures presented herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

During the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and at least one of A, B, and C, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in some embodiments the encoder signals (e.g., to a decoder) an MPD, adaptation set, a representation, a preselection, G-PCC components, a G-PCCComponent descriptor, a G-PCC descriptor or an essential property descriptor, a supplemental property descriptor, a G-PCC tile inventory descriptor, G-PCC static spatial regions descriptor, GPCCTileId descriptor GPCC3DRegionID descriptor, among other descriptors, elements and attributes, metadata, schemas, etc., etc. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Systems, methods, and instrumentalities are disclosed for coordinate refinement and/or up-sampling from quantized point cloud reconstruction. In examples, point-based coordinate refinement may be provided. An after-decoder point cloud refinement module (e.g., coarse point cloud refinement module) may include one or more of the following. The module may include accessing a coarse or decoded quantized version of a point cloud. The module may include accessing and/or fetching point(s) within a neighborhood area of each of the point(s). The module may include computing a feature using a convolution-based neural network module, for example, based on the voxelized version of the fetched points, e.g., that summarizes the details (e.g., intricate details). Another feature may be computed using a point-based neural network module, for example, based on the three-dimensional (3D) (e.g., or KD) location(s) of the fetched points, e.g., that summarizes the details (e.g., intricate details). In examples, the feature(s) may be concatenated to compose a comprehensive feature. A refinement offset for the current point may be predicted based on the comprehensive featuring using a fully connected (FC) module.

In examples, coordinate up-sampling may be provided. An after-decoder point cloud up-sampling module (e.g., coarse point cloud up-sampling module) may include one or more of the following. A decoded quantized version of a point cloud (e.g., coarse point cloud) may be accessed. The module may include accessing and/or fetching point(s) within a neighborhood area of each of the points. A feature (e.g., hybrid feature) may be computed using a neural network module based on the fetched point(s). Offsets for new points relative to the current point may be predicted through an FC module using the compute feature.

Many embodiments are described herein. Features of embodiments may be provided alone or in any combination, across various claim categories and types. Further, embodiments may include one or more of the features, devices, or aspects described herein, alone or in any combination, across various claim categories and types, such as, for example, any of the following.

A decoder, such as example decoder 300, configured to receive, decode and interpret signals (for example, as described herein) indicating elements, attributes and metadata associated with point cloud components, identify point cloud streams and their component sub-streams within a media presentation descriptor (MPD); identify versions of a point cloud and/or its components, decode an MPD to identify a main adaptation set and other adaptation sets to identify geometry-based point cloud compression (G-PCC) components in G-PCC content; decode an MPD to identify the type of point cloud component in an adaptation set or a representation; decode an MPD to identify one or more preselections; decode an MPD to identify one or more versions of G-PCC media; decode an MPD to identify one or more G-PCC tile groups; decoding an MPD to identify one or more tile IDs for a G-PCC component in an adaptation set; decode an MPD to identify one or more characteristics of spatial regions and mappings between the regions and G-PCC tiles, characteristics of spatial regions and mappings between the regions and corresponding adaptation sets of G-PCC components, and/or a mapping between a spatial region and corresponding adaptation sets of G-PCC components; decoding an MPD to identify a timed-metadata track for dynamic spatial regions; etc.

Decoding tools and techniques including one or more of entropy decoding, inverse quantization, inverse transformation, and differential decoding used to enable examples described herein in a decoder.

An encoder, such as example encoder 200, configured to, for example, generate, encode and send signals (for example, as described herein) indicating elements, attributes and metadata associated with point cloud components; encode an MPD to indicate point cloud streams and their component sub-streams; encode an MPD to indicate a main adaptation set and other adaptation sets to support identification of geometry-based point cloud compression (G-PCC) components in G-PCC content; encode an MPD to support identification of the type of point cloud component in an adaptation set or a representation; encode an MPD to identify one or more preselections; encode an MPD to support identification of one or more versions of G-PCC media; encode an MPD to support identification of one or more G-PCC tile groups; encoding an MPD to support identification of one or more tile IDs for a G-PCC component in an adaptation set; encode an MPD to support identification of one or more characteristics of spatial regions and mappings between the regions and G-PCC tiles, characteristics of spatial regions and mappings between the regions and corresponding adaptation sets of G-PCC components, and/or a mapping between a spatial region and corresponding adaptation sets of G-PCC components; decoding an MPD to identify a timed-metadata track for dynamic spatial regions; etc.

Encoding tools and techniques including one or more of quantization, entropy coding, inverse quantization, inverse transformation, and differential coding used to enable examples described herein in an encoder.

A syntax element(s) inserted in the signaling, for example, to enable the decoder to identify an indication associated with performing any of the examples described herein.

A syntax element(s) inserted in the signaling, for example, to enable an encoder to generate or encode an indication associated with performing any of the examples described herein.

A bitstream or signal may include one or more of the described syntax elements, or variations thereof associated with performing any of the examples described herein.

A method, process, apparatus, medium storing instructions, medium storing data, or signal for creating and/or transmitting and/or receiving and/or decoding a bitstream or signal that includes one or more of the described syntax elements, or variations thereof.

A method, process, apparatus, medium storing instructions, medium storing data, or signal for creating and/or transmitting and/or receiving and/or decoding according to any of the examples described herein.

A TV, set-top box, cell phone, tablet, or other electronic device that performs adaptive streaming of geometry-based point clouds, such as point cloud component substreams in point cloud streaming services, according to any of the examples described herein.

A TV, set-top box, call phone, tablet, or other electronic device that performs adaptive streaming of geometry-based point clouds, such as point cloud component substreams in point cloud streaming services, according to any of the examples described herein, and that displays (for example, using a monitor, screen, or other type of display) a resulting image.

A TV, set-top box, cell phone, tablet, or other electronic device that selects (for example, using a tuner) a channel to receive a signal including an encoded image, and performs adaptive streaming of geometry-based point clouds, such as point cloud component substreams in point cloud streaming services, according to any of the examples described herein.

A TV, set-top box, cell phone, tablet, or other electronic device that receives (for example, using an antenna) a signal over the air that includes an encoded image, and performs adaptive streaming of geometry-based point clouds, such as point cloud component substreams in point cloud streaming services, according to any of the examples described herein.

Tools for compression, analysis, interpolation, representation and/or understanding of point cloud compression and/or signals may be developed and/or used.

Point cloud data may be associated with a format. A point cloud may be associated with a (e.g., universal) data format used across (e.g., multiple) business domains, for example such as from autonomous driving, robotics, augmented reality/virtual reality (AR/VR), civil engineering, computer graphics, animation/movie industry, etc. Three-dimensional (3D) light detection and ranging (LiDAR) sensors may be deployed in devices, for example, self-driving cars, personal computing devices, LiDAR cameras, etc. 3D point cloud data may become more practical (e.g., with advances in sensing technologies) and may be expected to enable applications described herein.

Point cloud data may consume a large portion of network traffic. e.g., among connected cars over a network and/or over immersive communications (e.g., VR/AR). Efficient representation format(s) may be used for point cloud understanding and/or communication. For example, raw point cloud data may be organized and/or processed, e.g., for world modeling and/or sensing. Compression on raw point cloud(s) may be used, for example, if storing and/or transmission of the data is used as described herein.

Point cloud(s) may represent a sequential scan of the same scene, which may include multiple moving objects. The point clouds may be referred to as dynamic point clouds as compared to static point clouds captured from a static scene and/or static objects. Dynamic point clouds may be organized into frames with different frames being captured at different times. Dynamic point clouds may request that the processing and/or compression be in real-time and/or have low delay.

Point cloud data may be used as described herein. Point clouds may be used, for example in the automotive industry and/or autonomous car industry. Autonomous cars may (e.g., be able to) probe their environment to make correct driving decisions based on the reality of their immediate surroundings. Sensors (e.g., like LiDARs) may produce point clouds (e.g., dynamic point clouds) that may be used by the perception engine. At least some of the point clouds may not be intended to be viewed by human eyes and they may be sparse, not colored, and/or dynamic with a high frequency of capture. The point clouds may have other attributes, for example, such as the reflectance ratio provided by the LiDAR as this attribute is indicative of the material of the sensed object and may help in making a decision.

VR and immersive worlds may be used (e.g., included) in (e.g., the future of) two-dimensional (2D) flat video. VR and immersive worlds may immerse the viewer in an environment around the viewer and/or including the viewer as opposed to standard television (TV), for example, where the viewer may only be able to look at the virtual world in front of the viewer. There may be multiple gradations in the immersivity depending on the freedom of the viewer in the environment. Point cloud may be a practical format candidate to distribute VR worlds. The points clouds may be static or dynamic and may be of average size (e.g., no more than millions of points at a time).

Point clouds may be used for culture heritage/buildings in which objects like statues and/or buildings are scanned in 3D in order to share the spatial configuration of the object without sending or visiting it. This may be a way to ensure preserving the knowledge of the object in case the object is destroyed; for example, a temple by an earthquake. The point clouds may be static, colored, and/or huge.

Points clouds may be in topography and/or cartography in which, using 3D representations, maps may include relief (e.g., may not be limited to the plane). 3D maps may use meshes, for example, instead of or in addition to point clouds. Point clouds may be a suitable data format for 3D maps. The point clouds may be static, colored, and/or huge.

World modeling and/or sensing via point clouds may allow machines to gain knowledge about the 3D world around them, which may be used by applications (e.g., as described herein).

3D point cloud data may include one or more discrete sample(s) on the surfaces of objects and/or scenes. In examples, fully representing the real world with point samples may use a large number of points. For example, a VR immersive scene may include a large number (e.g., millions) of points, while point clouds may include larger number (e.g., hundreds of millions) of points. The processing of such large-scale point clouds may be computationally expensive, especially for consumer devices (e.g., smartphone, tablet, and automotive navigation system, which may have limited computational power).

Processing and/or inference of the point cloud may use efficient storage techniques. In examples (e.g., examples associated with storing and processing the input point cloud with affordable computational cost), a technique may include down-sampling the point-cloud (e.g., first), where the down-sampled point cloud summarizes the geometry of the input point cloud, e.g., while having much fewer points. The down-sampled point cloud may be fed to a subsequent machine task for consumption. Reduction in storage space may be achieved by converting the raw point cloud data (e.g., original or down-sampled) into a bitstream through entropy coding techniques for lossless compression. Entropy models may result in a smaller bitstream and efficient compression. The entropy models may be paired with downstream tasks, for example, which may allow the entropy encoder to maintain the task specific information while compressing.

In addition to lossless coding, a scenario may seek lossy coding for improved compression ratio while maintaining the induced distortion under quality levels.

Octree-based point cloud compression may be used. A point cloud may be represented via an octree decomposition tree. A root node may cover a full space in a bounding box. The space may be equally split in different (e.g., every) directions (e.g., x-, y-, and z-directions), leading to 8 voxels. For a voxel (e.g., each voxel) (e.g., if there is one or more point(s)) the voxel may be marked to be occupied, e.g., represented by ‘1’; otherwise, it may be marked to be empty, e.g., represented by ‘0’. The root voxel node may be described by an 8-bit value.

For an occupied voxel (e.g., each occupied voxel), its space may be further split into 8 child voxels (e.g., moved to the next level of octree). The current voxel may be further represented by an 8-bit value, for example, based on the occupancy of the child voxels.

The splitting of occupied voxels may continue, for example, until a specific (e.g., the last) octree depth level. The leaves of the octree may represent a point cloud. On the encoder side, the octree nodes (e.g., node values) may be sent to an entropy coder to generate a bitstream. A decoder may use the decoded octree node values to reconstruct the octree structure and may reconstruct a point cloud, for example, based on the leaf nodes of the octree structure.

In examples, to efficiently entropy code the octree nodes, a probability distribution model may be utilized to allocate a shorter symbol for octree node values appearing with higher probability.

Octree-based coding of point cloud data may result in multiple quantized versions of the same point cloud for different bitrate requirements. The quantized versions may include fewer points than the original point cloud and may be considered the final reconstruction for that bitrate. Refining the quantized reconstructions to improve the quality of the point cloud without incurring additional bitrate costs may be provided herein.

Learning-based coordinate refinement and up-sampling may be performed (e.g., provided). Coordinate refinement may be compromised if (e.g., when) a quantized version of an input point cloud is involved. In examples, a quantized version of a point cloud may be obtained during lossy compression at low bitrates. Quantization may be performed (e.g., done) on the input point cloud, e.g., before (or during) compression, to obtain integer coordinate position(s) which are amenable to arithmetic coding techniques. Finer details (e.g., intricate details) associated with the point cloud may be lost as a result of quantization. The details may be recovered using a coordinate refinement technique, for example, operating on a per-point basis. One such learning-based technique may have been presented in VoxelContextNet (e.g., as illustrated in FIG. 5). A learning-based technique may use 3D convolutions over spatial neighbor voxels to obtain feature(s) for the local surface shape which were used to refine the position of one or more quantized points (e.g., each quantized point). The coordinate refinement network may be trained with a mean squared error (MSE) loss in reference to the original point cloud and may be served as a metric of agreement between the two.

Learning-based up-sampling may be performed (e.g., because point cloud data obtained from 3D scanning may be sparse and non-uniformly distributed). Up-sampling may result in generating dense point sets from the sparse point clouds. In examples, to achieve this result, multiple types of architectures may be used, for example, such as convolution, graph convolutions, Generative Adversarial Networks (GANs), etc., which may operate on either the whole point cloud or patches from the point clouds for up-sampling.

A point-based coordinate refinement module (e.g., PointCRM) may be used. The coordinates of a quantized point cloud may be refined, for example, using (e.g., through) deep learning-based refinement (e.g., a deep learning-based refinement module). The deep learning-based refinement (e.g., module) may be utilized to extract a feature descriptor characterizing a local surface. In contrast to the CRM in VoxelContextNet, the 3D locations of nodes in the neighborhood may be considered for example, instead of making a binary voxelized neighborhood to represent nodes in the neighborhood. A CRM may use 3D convolutions for feature extraction from the voxelized neighborhoods. A 3D convolution-based architecture may be used for repeatable patterns in the 3D space, for example, but may miss details within the scene. A CRM (e.g., referenced as PointCRM) may use a multi-layer perception (MLP)-based architecture, for example, which may be suitable for extracting the details.

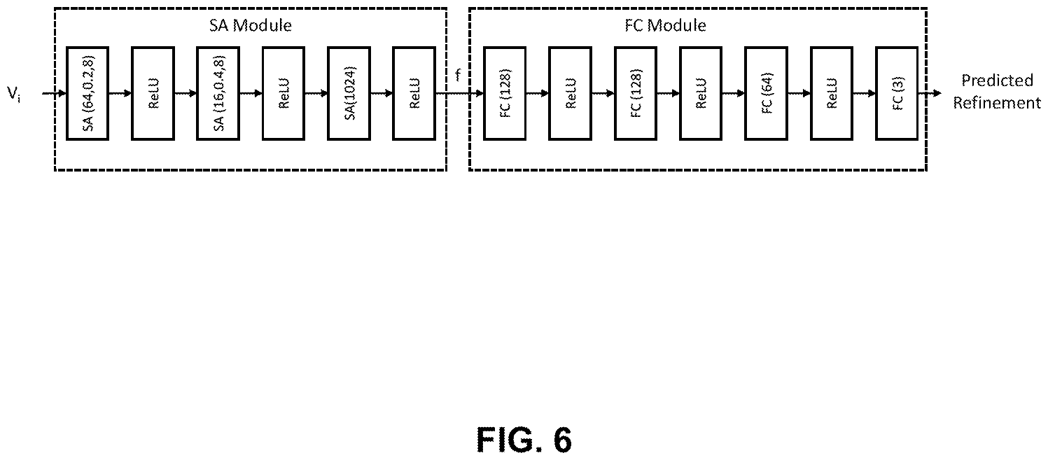

A basic PointCRM architecture may be provided and/or used. The PointCRM may be deployed via a point-based neural network, e.g., which utilizes an MLP architecture. In examples, a set abstraction (SA) module may be used which may output an MLP-based feature f as shown in FIG. 6. FIG. 6 shows an example of a basic point-based coordinate refinement module (e.g., PointCRM). The point-based network may be used (e.g., capable) to represent intricate structures within a surface. PointCRM may take a point set Vᵢ as input (e.g., that is from a neighborhood of a current quantized point). Vᵢ may be provided in the form of 3D positions of the neighboring quantized points relative to the current quantized point. The output feature f may be processed through further layers to produce the coordinate refinement for one or more quantized point(s) (e.g., each quantized point).

For a design of the point-based architecture as shown in FIG. 6, the network may be composed of three SA layers followed by four fully connected (FC) layers. FIG. 6 illustrates configuration of one or more layers (e.g., each layer). As shown in FIG. 6, SA(64,0.2.8) may indicate that the input points (e.g., all input points) are abstracted as 64 points, each with a neighborhood radius of 0.2 by using 8 nearest neighbors. SA(1024) may indicate that points (e.g., all points) are abstracted as a single point with a feature vector of size 1024. FC(128) may indicate that a fully connected layer with output size 128. The last FC layer may have an output of size 3, for example, corresponding to predicted offset/refinement to the quantized point location. The predicted offset may be added to the quantized point location, for example, to obtain the updated position. The updated position may improve the reconstruction quality when compared to the original point cloud.

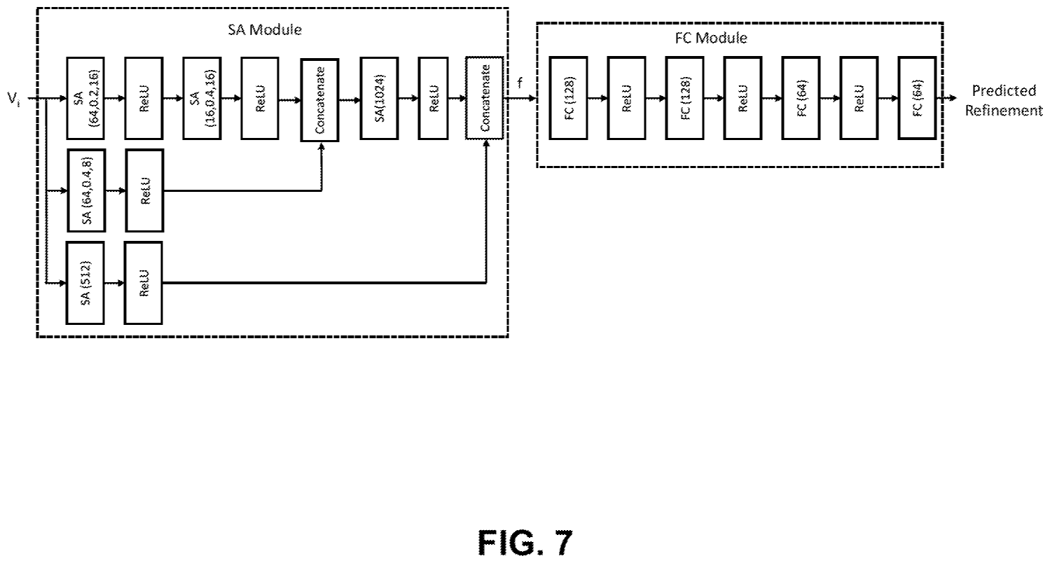

A multi-resolution grouping (MRG)-enhanced PointCRM architecture may be used and/or provided. The basic PointCRM module may be enhanced (e.g., improved) by an MRG strategy as shown in FIG. 7. FIG. 7 shows an example of a multi-resolution grouping-enhanced (MRG-enhanced) PointCRM. With the MRG strategy, the features from across abstraction levels may be concatenated together to form the output feature f.

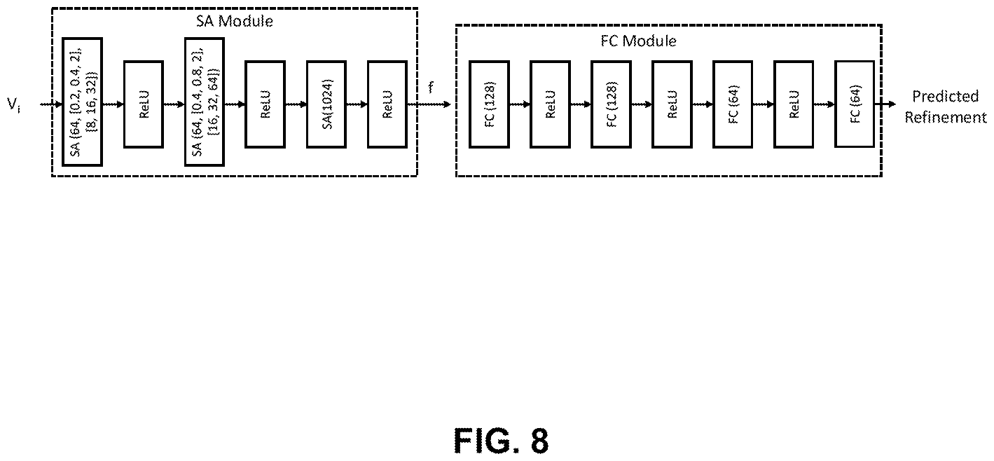

A multi-scale grouping (MSG)-enhanced PointCRM architecture may be provided. In examples, the PointCRM may be enhanced using an MSG strategy as shown in FIG. 8. FIG. 8 shows an example of a multi-scale grouping-enhanced (MSG-enhanced) PointCRM. With the MSG strategy, features may be extracted and combined from different scales at the same level of abstraction to form the output feature f.

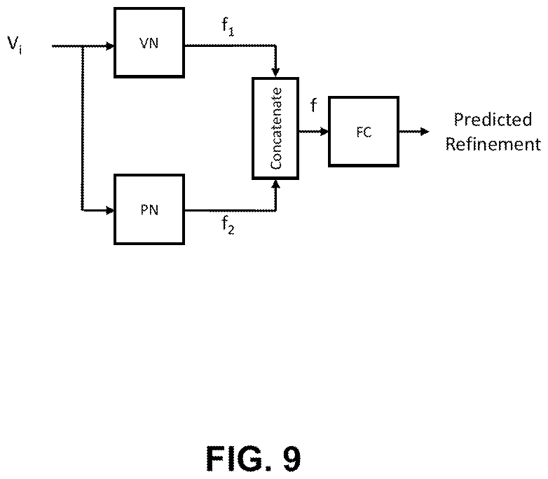

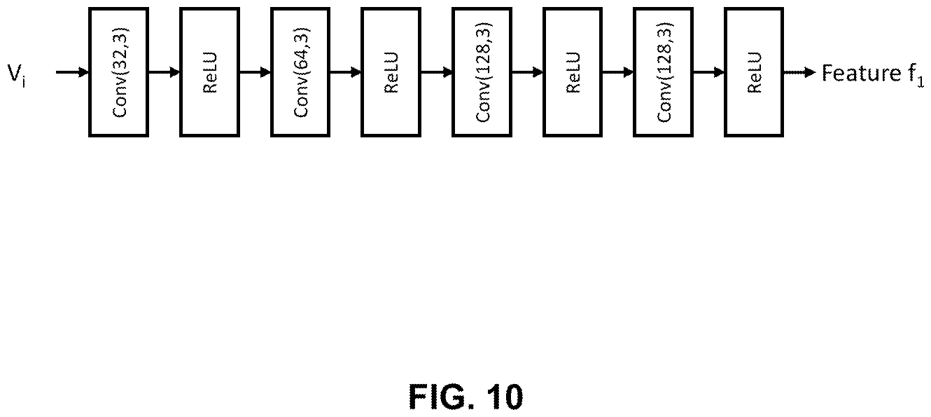

A hybrid PointCRM architecture (PVCRM) may be provided. In examples, the PointCRM may be enhanced using a hybrid strategy as shown in FIG. 9. FIG. 9 shows an example of a hybrid architecture. VN may refer to voxel-based convolution branch and PN may refer to a point-based MLP branch. With hybrid strategy, features may be extracted and combined from convolution-based (e.g., as shown in FIG. 10) and point-based branches in parallel to form the output feature f. FIG. 10 shows an example of a convolution-based branch.

A point-based up-sampling module (PointUPM) may be provided. CRM may refine the position of a decoded point (e.g., each decoded point) in the quantized point cloud. For example, the point cloud may be a coarse point cloud. The number of points in the quantized point cloud may be less than (e.g., no more than) the number of points in the original point cloud (e.g., a coarse point cloud), for example, which may put an upper limit to the peak signal-to-noise ratio (PSNR) that may be achieved by just refining point positions. For example, the coarse point cloud may be a thinner point cloud (e.g., containing less than the number of points in the original point cloud. A point cloud may be coarse, for example, based on coding. A point cloud may be coarse, for example, based on losing some points from the original point cloud. Points may be added (e.g., it may be better to add points) for a decoded point (e.g., each decoded point) in the quantized point cloud, e.g., specifically at the lower bitrates which have more quantization. A point-based up-sampling module that predicts multiple offsets (e.g., instead of one like in CRM) may be used to add multiple points with refined positions. The first head in UPM may be (e.g., similar to CRM) one or more of the following: 3D CNN-based UPM, SA-based PointUPM, MRG-enhanced PointUPM, MSG-enhanced PointUPM, or hybrid PointUPM.

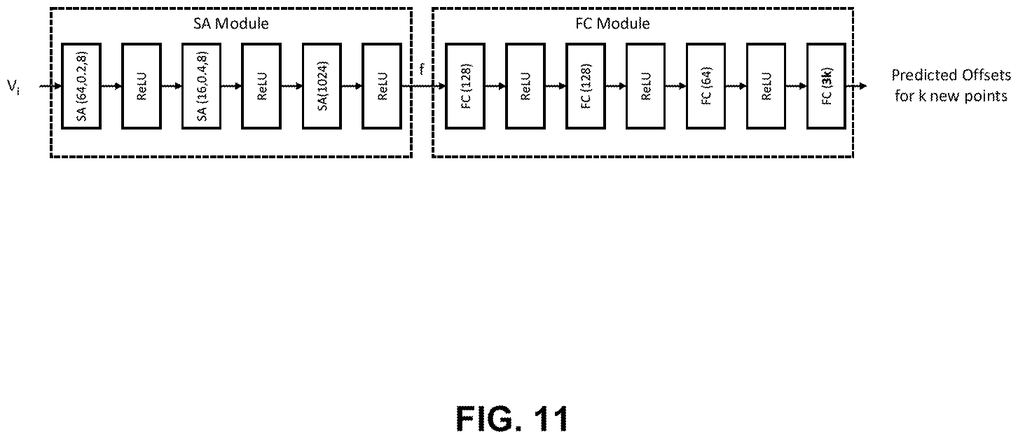

A basic UPM architecture may be used and/or provided. In a basic UPM architecture, the last layer in the network may output 3k values, where k is the value of the desired upsampling ratio. Note that having k=1 may indicate (e.g., make) the CRM architecture and having k>1 may indicate (e.g., make) the UPM architecture. FIG. 11 shows an example of a basic point-based up-sampling module (PointUPM).

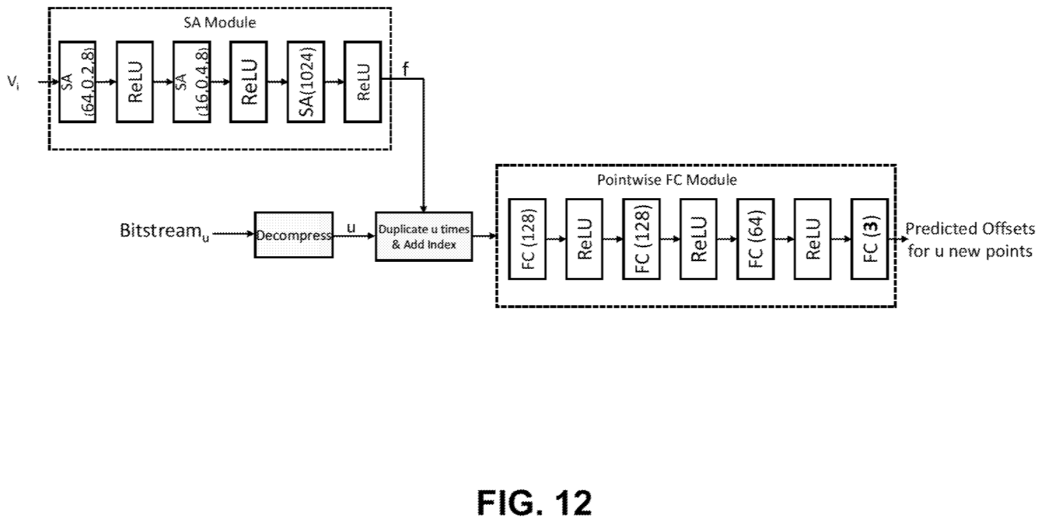

A basic UPM architecture with exact point matching may be used (e.g., provided). In examples, the UPM architecture may be enhanced (e.g., improved) to output the exact number of points as the original input point cloud. Achieving this may involve signaling within the bitstream the number of up-sampled points associated with a quantized point (e.g., each quantized point). With the number of up-sampled points for each quantized point, u, the architecture of the final FC layer in UPM may be modified to generate u distinct points. U copies of the feature vector f may be made, for example, each appended with an index in range [0,u−1]. The extended copies may be input to the FC layer to generate 3u values corresponding to u offsets associated with u new points. FIG. 12 shows an example of a basic PointUPM with exact point matching.

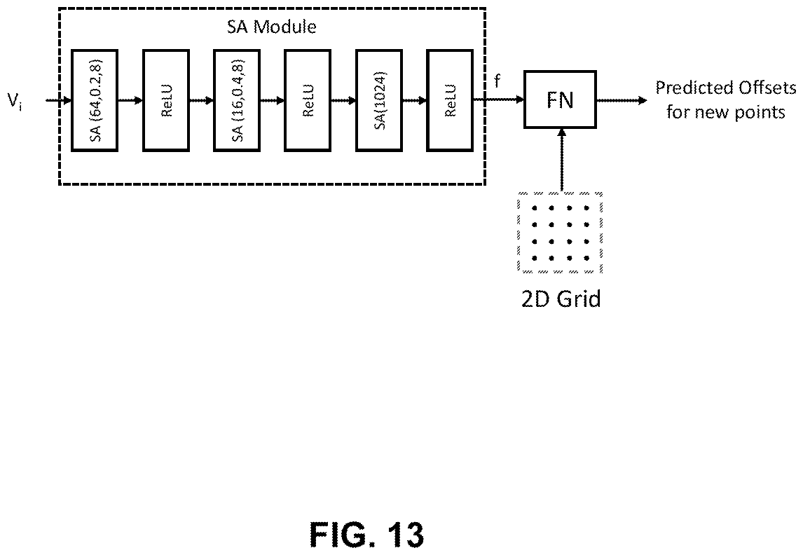

A folding-enhanced UPM architecture with exact point matching may be provided. In examples, the final FC layer may be replaced with a FoldingNet to generate the offsets for an upsampled (e.g., new) point (e.g., each upsampled/new point). FIG. 13 shows an example of a folding-enhanced PointUPM.

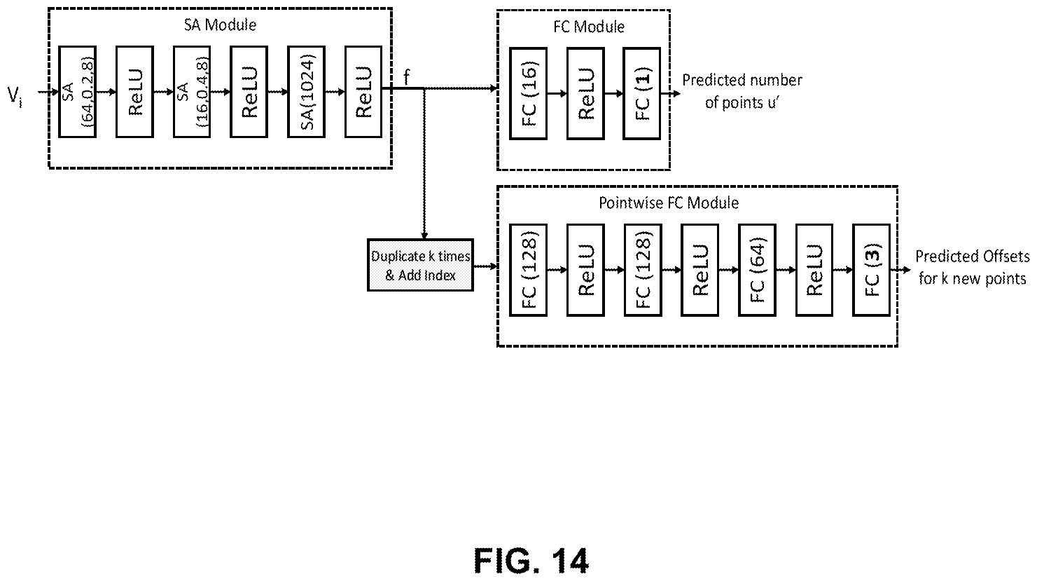

A prediction-based UPM architecture may be provided. In examples, an additional FC head may be added to the UPM architecture that predicts the optimal number to be used for up-sampling, u′. The FC head may be trained with a number (e.g., the actual number) of up-sampled points for each quantized point u, along with the L1-loss. The architecture for this UPM is shown in FIG. 14. FIG. 14 shows an example of a prediction-based UPM.

During inference, the first FC head may output a fixed number of offsets, out of which u′ offsets may be picked, for example, based on the output of the prediction FC head. The architecture may result in additional information not needing to be transferred and bitrate costs may not increase.

A residual coding-based UPM Architecture with exact point matching may be provided. In examples, the prediction-based UPM architecture may be used to compute the residual between the predicted and the actual number of upsampled points. The residual may be added to the bitstream to obtain the original number of up-sampled points on the decoder side to match the exact number of points as the input point cloud.

Advanced PointCRM and/or PointUPM architectures may be provided. The PointCRM and/or PointUPM architectures can be enhanced (e.g., further enhanced), for example, by swapping modules (e.g., the existing modules) with micro-architectures (e.g., more advanced micro-architectures). A version (e.g., an advanced version) of the architecture can be realized, for example, by considering the features from octree levels (e.g., previous octree levels, already decoded octree levels). The architectures may be enhanced, for example, as described herein.

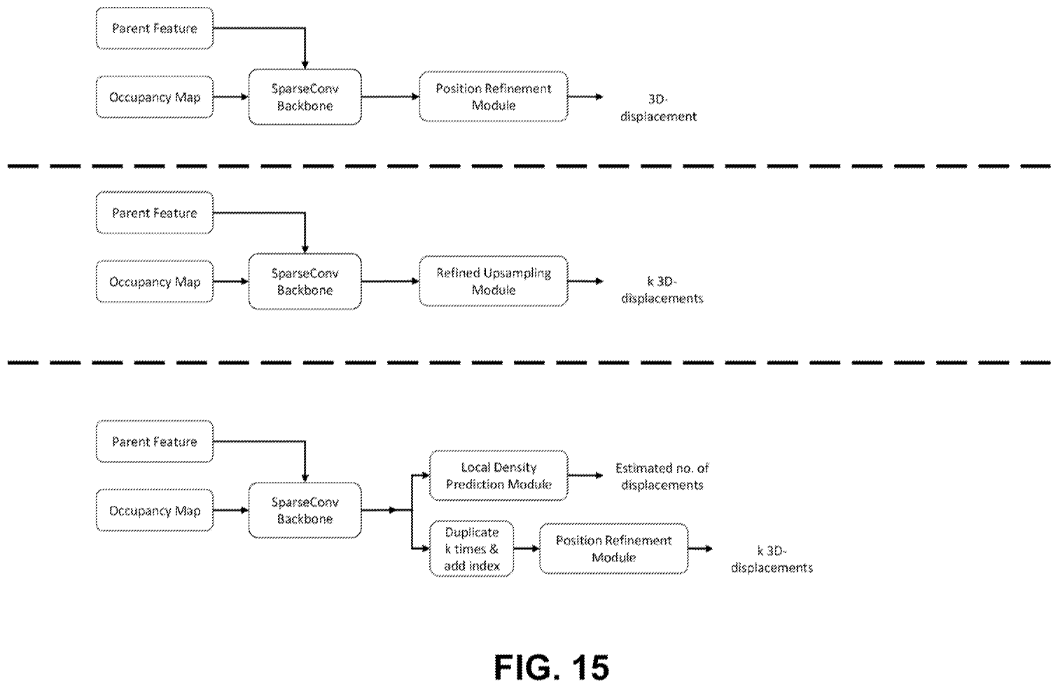

Hierarchical feature propagation may be performed. FIG. 15 shows an example of hierarchical feature propagation. In examples (e.g., for PointCRM and PointUPM architectures), the occupancy information at the current decoded level is used (e.g., only the occupancy information is used) for position refinement and upsampling. In examples (e.g., for a more advanced version of the models as described herein), the features from the previous level (e.g., parent, already decoded level) may be upsampled, for example, to match the resolution of the current octree level. The upsampled features may be propagated to the child nodes, for example, for predicting the point refinements at the current level.

The features from the previous (e.g., parent) level may be available (e.g., already available) if (e.g., when) decoding for nodes at the current level. The features from the parent level may be upsampled, for example, to obtain distinctive features for (e.g., all) child nodes at the current level. This upsampling can be done (e.g., performed), for example, using on one or more of the following: an MLP based module (e.g., which may take a feature vector and an index corresponding to the child node to output a feature for the corresponding child node a regular or sparse convolution-based module (e.g., which may take the feature map (e.g., all the feature map, the whole feature map) at the parent level and output an upsampled feature map with features for the (e.g., all) nodes at the current level), etc. The feature can be paired (e.g., concatenated or added) to a feature of the current node (e.g., obtained from its neighborhood occupancy information), for example, via an MLP or regular/sparse convolution-based module. The combined feature can be propagated (e.g., again be propagated) through a feature aggregator architecture, for example, to arrive at a final deep feature. The deep feature may be used by the FC offset prediction module to output the point position updates. A depiction of the proposed hierarchical feature propagation is shown in FIG. 15.

Advanced micro-architectures may be determined and/or provided. For example, architectures (e.g., more advanced architectures) like convolutions, sparse convolutions, ResNet (e.g., residual network), Inception ResNets, and transformers (e.g., attention-based models), etc. can be used for extracting and propagating the features, for example, rather than using MLPs and convolution-based layers to extract and propagate the features in PointCRM and PointUPM. An enhanced feature extraction aggregation capability may be provided, for example, using certain architectures (e.g., more advanced architectures, such as, convolutions, sparse convolutions, ResNet (residual network), Inception ResNets, and transformers (attention-based models)). Convolution based micro-architectures (e.g., all convolution based micro-architectures) can be used in the voxel branch. MLP based micro-architectures can be used in the point branch, for example, as described herein.

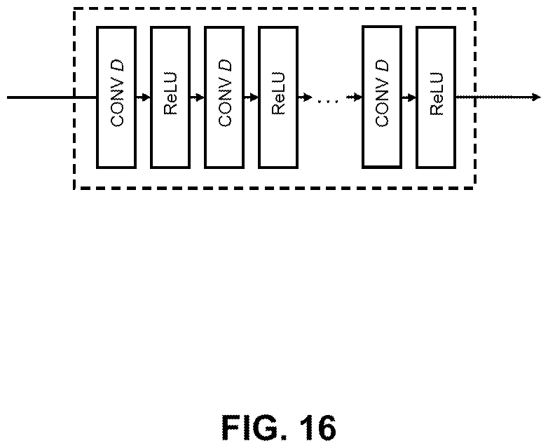

In examples, the voxel based feature extractor may include convolutional layer(s) (e.g., a series of sparse 3D convolutional layers), for example, with a ReLU activation function (e.g., following every 3D convolution, as shown in FIG. 16). FIG. 16 illustrates an example voxel branch based on sparse convolutions. CONV D may denote a sparse 3D convolution layer with D output channels.

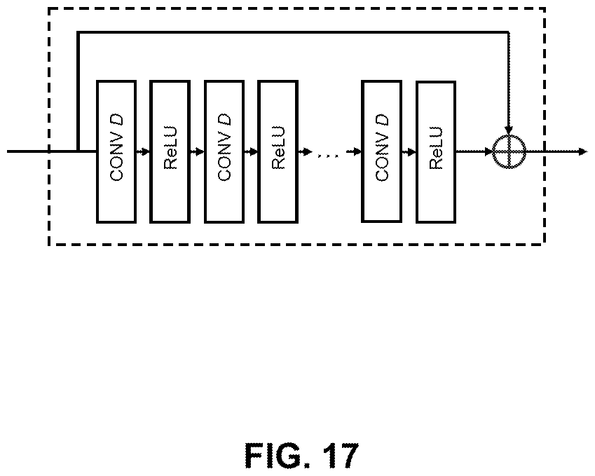

In examples, the feature aggregation module may take the ResNet architecture, as shown in FIG. 17. FIG. 17 illustrates an example voxel branch based on ResNet composed of sparse convolutions. The architecture of a ResNet block may aggregate features with D channels. FIG. 17 illustrates a residual connection from the input and added with the output of the convolutional layers. This residual connection may be formed for an MLP based architecture, for example, instead of a convolutional architecture.

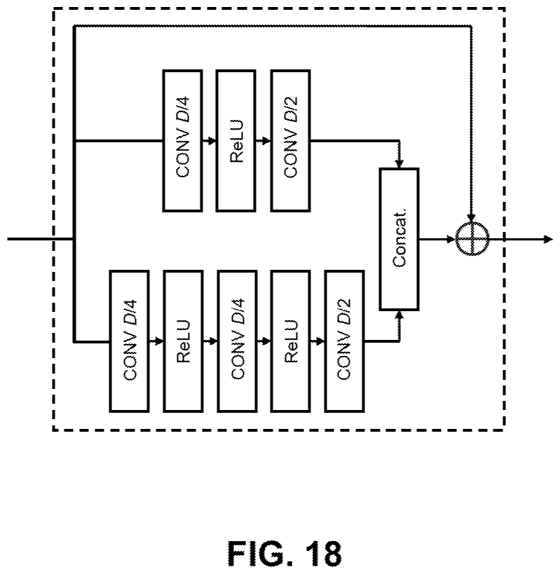

In examples, the feature aggregation module may take the Inception-ResNet (IRN) architecture, as shown in FIG. 18. FIG. 18 illustrates an example of a voxel branch based on Inception ResNet composed of sparse convolutions (e.g., an example architecture of an IRN block to aggregate features with D channels).

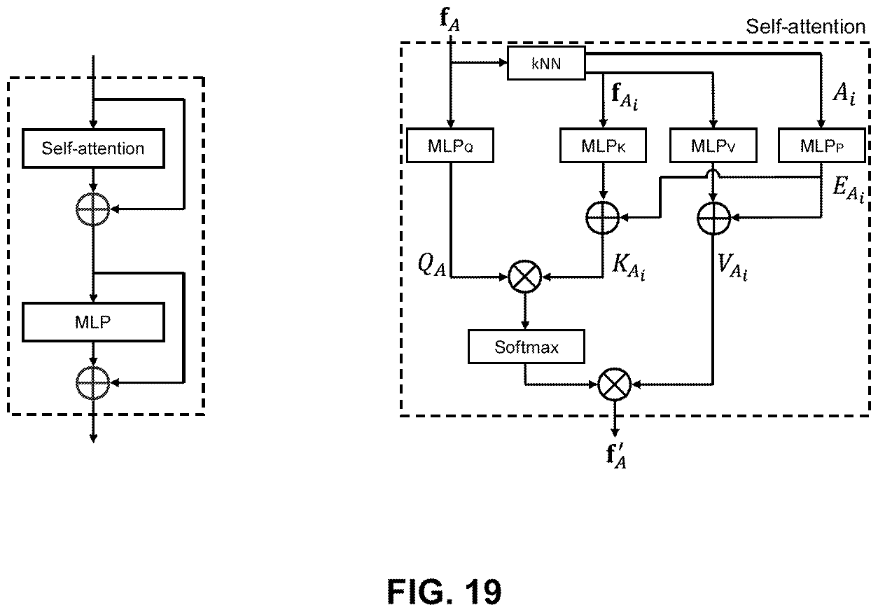

In examples, the feature propagation module may take the form of transformer architecture (e.g., similar to the voxel transformer as described herein). FIG. 19 illustrates a diagram of an example point branch based on a transformer block. The example transformer block may include a self-attention block with residual connection, and a MLP block (e.g., consisting of MLP layers) with residual connection. The block diagram of the self-attention block shown in FIG. 19 is described herein.

Given a current feature vector f_{A} associated with a voxel location A. and its neighboring k features f_{Ai} associated with voxel locations Ai, where Ai (e.g., 0≤i≤k−1) are the k nearest neighbors of A in the input sparse tensor, the self-attention block may (e.g., endeavor to) update the feature f_{A} based on all the neighboring features f_{Ai}. The points Ai may be obtained by a k nearest neighbor (kNN) search, for example, based on the coordinate of A. The query embedding Q_{A} for A may be computed using Eq. 1.

$${Q}_{A} = M L {P}_{Q} ( {f}_{A} ) \qquad Eq . 1$$

The key embedding K_{Ai} and the value embedding V_{Ai} of (e.g., all) the nearest neighbors of A may be computed, for example, using Eq. 2.

$${K}_{Ai} = {MLP}_{K} ( {f}_{Ai} ) + {E}_{Ai} , {V}_{Ai} = {MLP}_{V} ( {f}_{Ai} ) + {E}_{Ai} , 0 \leq i \leq k - 1 \qquad Eq . 2$$

where MLP_{Q}(·), MLP_{K}(·), and MLP_{V}(·) may be MLP layers to obtain the query, key, and value respectively, and EAi may be the positional encoding between the voxels A and Ai, for example, calculated using Eq. 3.

$${E}_{Ai} = {MLP}_{P} ( {P}_{A} - {P}_{Ai} ) , \qquad Eq . 3$$

where MLP_{P}(·) may be MLP layers to obtain the positional encoding, and P_{A} and P_{Ai} may be 3-D coordinates (e.g., centers of the voxels A and Ai, respectively). The output feature of location A by the self-attention block may be determined using Eq. 4.

$${f}_{A}^{′} = {\sum }_{i = 0}^{k - 1} σ ( \frac{( {Q}_{A}^{T} \cdot {K}_{i}}{c \sqrt{d}} ) \cdot {V}_{{A}_{i}} \qquad Eq . 4$$

where σ(·) may be the Softmax normalization function, d may be the length of the feature vector f_{A} and c may be a pre-defined constant.

The transformer block may update the feature for (e.g., all) the occupied locations in the sparse tensor (e.g., in the same way). The transformer block may (e.g., then) output the updated sparse tensor. In examples (e.g., in simplified examples), MLP_{Q}(·), MLP_{K}(·), MLP_{V}(·), and MLP_{P}(·) may include a fully-connected layer (e.g., only one fully-connected layer), for example, which may correspond to linear projections.

In examples, feature aggregation blocks (e.g., several feature aggregation blocks) can be cascaded together (e.g., in series) to further enhance the performance. The feature aggregation blocks can be of the same type, e.g., (e.g., all of them are) transformer blocks. In this case, the parameters of their neural network layers can be shared or not shared. The feature aggregation blocks can (e.g., also) be a mixture of different (e.g., suitable) types of feature aggregation blocks. e.g., a mixture of the IRN blocks and the transformer blocks.

In-loop use for point cloud compression may be performed.

CRM (e.g., as described herein) may be used (e.g., as a post-processing) to enhance the point cloud quality before being outputted. CRM may be used to enhance the reference point clouds in an in-loop manner, for example, if (e.g., when) inter-prediction is to be deployed for dynamic point cloud compression. CRM may represent approaches (e.g., any approaches, as described herein) presented in previous sections to do coordinate refinement or upsampling.

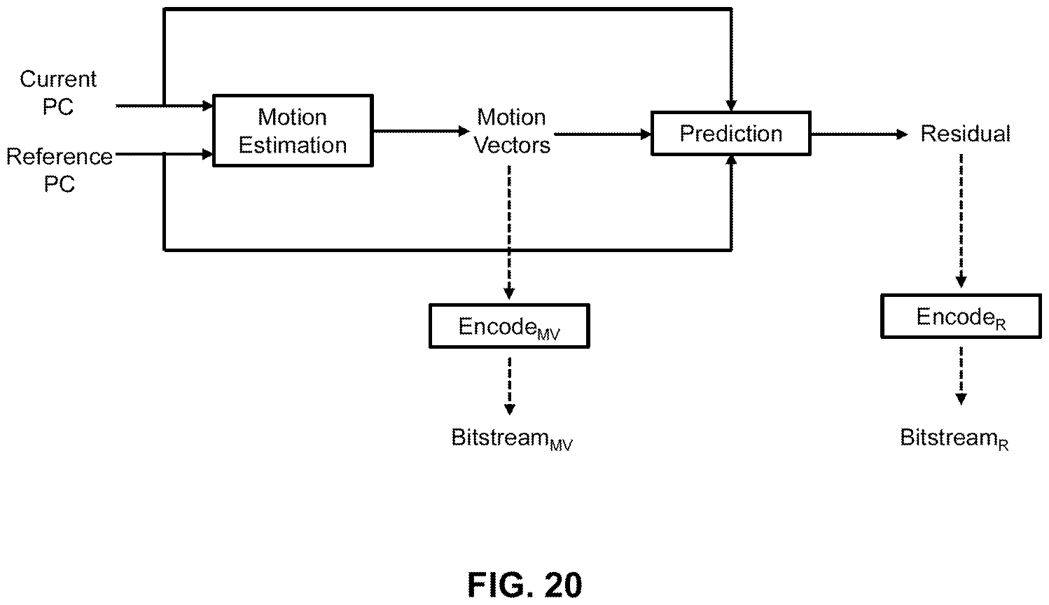

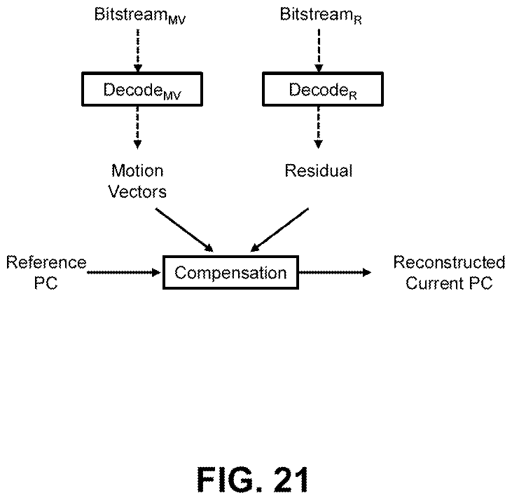

FIG. 20 illustrates an example inter-coding diagram for dynamic point cloud compression. A reference point cloud frame may be supplied, for example, to encode a current point cloud frame. Both PC frames may be fed to a motion estimation module. The generated motion vectors may be provided for a “Prediction” module, which may output a residual information. The motion vectors and residual information may be encoded, for example, into bitstreams. FIG. 21 illustrates an example decoder for inter-coding for dynamic point cloud compression. As illustrated, the motion vectors and residuals may be decoded (e.g., decoded first). The motion vectors and residuals may be fed together with the reference point cloud frame to a compensation module. A reconstruction of the current point cloud frame may be generated as an output.

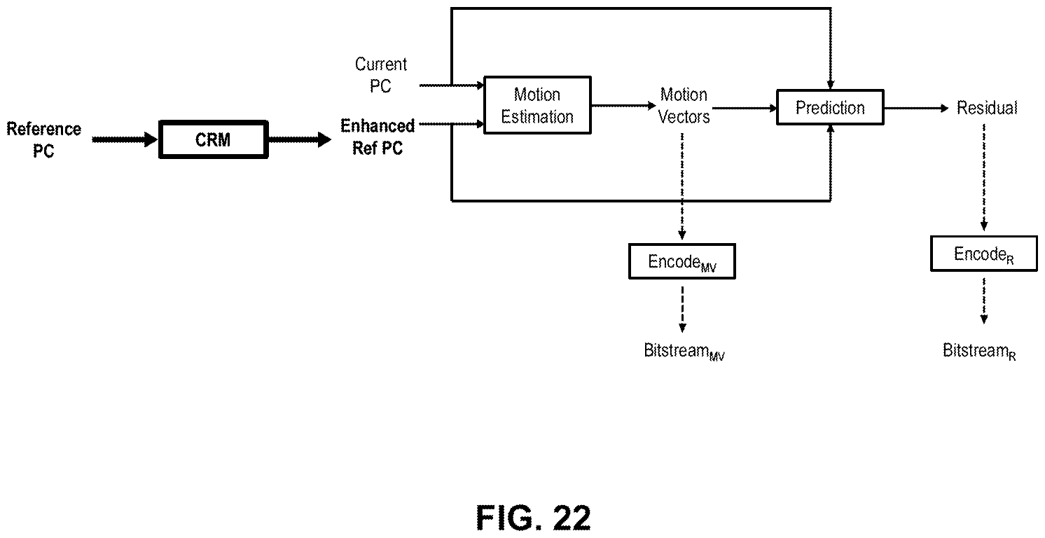

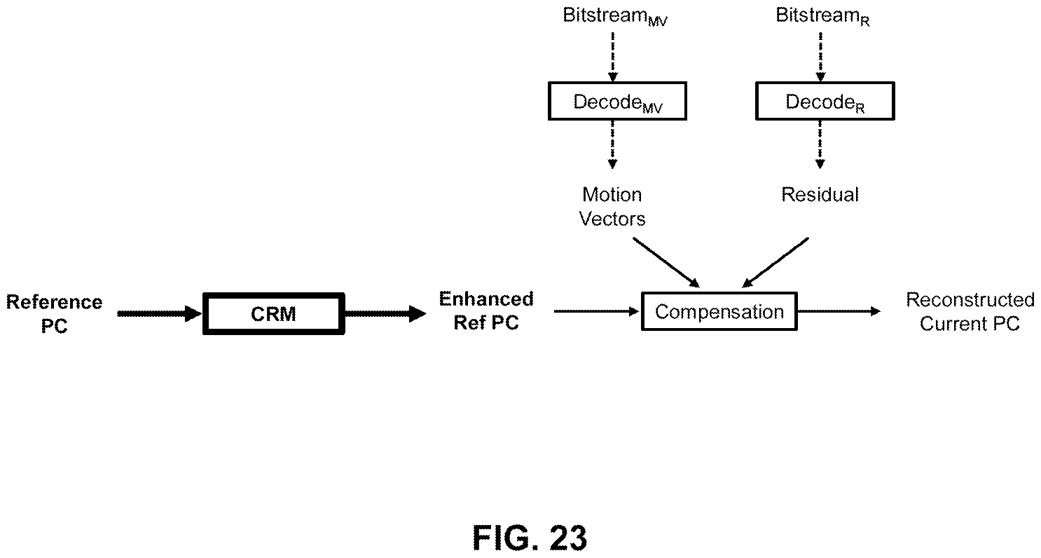

The CRM (e.g., as described herein) may enhance the reference point cloud frame, for example, before it is used to be a reference. FIG. 22 illustrates an example updated inter-coding diagram. As shown in FIG. 22, an encoder may use inter-prediction based on an enhanced reference PC. The reference point cloud frame may be processed by a CRM module (e.g., as described herein). The enhanced reference point cloud may replace the original reference point cloud to perform motion estimation. The same update may be used in an updated decoder as illustrated in FIG. 23. FIG. 23 illustrates an example decoder using inter-prediction based on an enhanced reference PC.

Coding techniques for point cloud data may produce quantized and/or down-sampled reconstructions of the original point cloud at each bitrate. In examples, e.g., since point cloud data represents real world objects with smooth surfaces, each quantized reconstruction may include local surface information that may be used for further refinement of a point coordinate (e.g., each point coordinate). The local information may be exploited to up-sample the point cloud for improvement of the reconstruction quality. Multiple architectures to achieve coordinate refinement as described herein and up-sampling by analyzing the local quantized surfaces may be provided.

Hierarchical feature propagation from the already decoded resolution (e.g., octree level) may be performed, for example, by upsampling the features from the parent level, e.g., to bring them to the resolution of the current level (e.g., before further feature aggregation), for example, which can (e.g., further) improve the richness of the current (e.g., level) feature.

Although features and elements are described above in particular combinations, one of ordinary skills in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-18. (canceled)

19. A device, the device comprising:
a processor configured to:
obtain a quantized point cloud associated with a frame, wherein the quantized point cloud comprises a current point;
determine a set of neighboring points associated with the current point of the quantized point cloud;
determine a first feature associated with the current point, wherein the first feature is determined using a point-based neural network technique;
predict an offset associated with the current point based on the first feature; and
determine an updated quantized point cloud associated with the frame based on the current point and the predicted offset.

20. The device of claim 19, wherein the processor is further configured to:
generate an upsampled point based on the quantized point cloud; and
predict an offset associated with the upsampled point based on the first feature.

21. The device of claim 19, wherein the processor is further configured to:
determine a quantization associated with the quantized point cloud; and
based on a determination that the quantization is above or equal to a threshold, generate at least one upsampled point to generate an upsampled quantized point cloud, wherein the upsampled quantized point cloud comprises one of a uniform addition of points to the quantized point cloud or a non-uniform addition of points to the quantized point cloud.

22. The device of claim 19, wherein the point-based neural network technique uses a point-based representation of the set of neighboring points.

23. The device of claim 22, wherein the point-based representation of the set of neighboring points is associated with three dimensional (3D) or k-dimensional (KD) locations of the set of neighboring points.

24. The device of claim 19, wherein the processor is further configured to:
deploy a point-based neural network, wherein the point-based neural network technique uses the point-based neural network.

25. The device of claim 19, wherein the first feature comprises information associated with intricate details of an object.

26. The device of claim 19, wherein the processor is further configured to:
determine a second feature associated with an object, wherein the second feature is determined using a voxel-based neural network technique; and
combine the first feature and the second feature into a combined feature, wherein the offset associated with the current point is further predicted based on the combined feature.

27. The device of claim 26, wherein the voxel-based neural network technique uses a voxelized version of the set of neighboring points, and wherein the voxel-based neural network technique uses a convolutional neural network.

28. The device of claim 19, wherein the processor is further configured to:
generate an upsampled point based on the quantized point cloud;
determine a second feature associated with an object, wherein the second feature is determined using a voxel-based neural network technique;
combine the first feature and the second feature into a combined feature; and
predict an offset associated with the upsampled point based on the combined feature.

29. A method, the method comprising:
obtaining a quantized point cloud associated with a frame, wherein the quantized point cloud comprises a current point;
determining a set of neighboring points associated with the current point of the quantized point cloud;
determining a first feature associated with the current point, wherein the first feature is determined using a point-based neural network technique;
predicting an offset associated with the current point based on the first feature; and
determining an updated quantized point cloud associated with the frame based on the current point and the predicted offset.

30. The method of claim 29, wherein the method further comprises:
generating an upsampled point based on the quantized point cloud; and
predicting an offset associated with the upsampled point based on the first feature.

31. The method of claim 29, wherein the method further comprises:
determining a quantization associated with the quantized point cloud; and
based on a determination that the quantization is above or equal to a threshold, generating at least one upsampled point to generate an upsampled quantized point cloud, wherein the upsampled quantized point cloud comprises one of a uniform addition of points to the quantized point cloud or a non-uniform addition of points to the quantized point cloud.

32. The method of claim 29, wherein the point-based neural network technique uses a point-based representation of the set of neighboring points.

33. The method of claim 32, wherein the point-based representation of the set of neighboring points is associated with three dimensional (3D) or k-dimensional (KD) locations of the set of neighboring points.

34. The method of claim 29, wherein the method further comprises:
deploying a point-based neural network, wherein the point-based neural network technique uses the point-based neural network.

35. The method of claim 29, wherein the first feature comprises information associated with intricate details of an object.

36. The method of claim 29, wherein the method further comprises:
determining a second feature associated with an object, wherein the second feature is determined using a voxel-based neural network technique; and
combining the first feature and the second feature into a combined feature, wherein the offset associated with the current point is further predicted based on the combined feature.

37. The method of claim 26, wherein the voxel-based neural network technique uses a voxelized version of the set of neighboring points, and wherein the voxel-based neural network technique uses a convolutional neural network.

38. The method of claim 29, wherein the method further comprises:
generating an upsampled point based on the quantized point cloud;
determining a second feature associated with an object, wherein the second feature is determined using a voxel-based neural network technique;
combining the first feature and the second feature into a combined feature; and
predicting an offset associated with the upsampled point based on the combined feature.
